(19) United States
(12) Patent Application Publication
(10) Pub. No.: US 2004/0126107 A1
(43) Pub. Date: Jul. 1, 2004

(54) Optical control system

(75) Inventors: Paul R. Jay, Stittsville (CA); Robert Andrews, Kanata (CA); Paul Dietz, Ottawa (CA); Zeljko Ribaric, Kanata (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: Intelligent Photonics Control Corporation, Kanata (CA)

(21) Appl. No.: 10/331,763

(22) Filed: Dec. 31, 2002

(51) Int. Cl. H04B 10/08

(52) U.S. Cl. 398/25

(57) ABSTRACT

A multi-level control system for optical components is disclosed herein. The control of optical components uses the representation of an optical component as an optical function, and the ability to represent a plurality of optical functions as a compound optical function that can be controlled by a higher level controller. Controllers of the present invention are designed to treat the controlled system as an object, so that a single controller can interact with other controllers either in a peer-to-peer, or master-to-slave relationship

### FIELD OF THE INVENTION

The present invention relates generally to the control of optical components. More particularly, the present invention relates to coordinated control of a series of optical components.

### BACKGROUND OF THE INVENTION

Many optical components used in networks are active components that are connected to power supplies and are variously used to amplify, regenerate and route optical signals. Typically, these components are manufactured to provide characteristic performance within a fixed range of operational parameters. For example, a semiconductor optical amplifier (SOA) may be designed to provide a nominal 12 dB gain at an operational temperature range of 15-30° C.

In network design it is assumed that such components will perform within their defined range, whereas there may be significant drift in their characteristics over the lifespan of the components. To ensure that an optical component will meet its specifications, component manufacturers must typically manufacture the components to provide better performance over a wider operational range. This over-design ensures that a component will meet its specifications even if it is required to operate in a non-optimal environment for a period of time.

The fact that a component may be able to perform above specified levels has prompted the deployment of remotely-configurable optical controllers designed to allow a network planner to tweak network performance, and be assured that as a component ages and undergoes operational stress, its performance does not drift. The drift of a component from its initially calibrated levels can result in variations in the output signal's power or wavelength, or the power per wavelength, and can also result in the addition of unexpected noise, phase shifts, polarisation or changes to the modulation of a signal.

In controlling an optical component, the component is modelled as an optical function that maps an input signal to an output signal. The mapping function, also referred to as a transfer function, is directly affected by variables, such as the operational temperature of the component, and the power provided to the optical component to perform functions such as amplification. Some of these variables, such as the power provided to the component, can be varied by an optical controller. As illustrated in FIG. 1, conventional optical controllers employ feedback to regulate the control of the optical function and to establish a closed loop control system. A first optical component, OC_{X}, 100, is controlled by controller_{X} 102. OC_{X} 100 receives an input signal 104, a portion of which is tapped to controllers 102. OC_{X} 100 performs its optical function on the input signal, and provides output signal 106, a portion of which can also be tapped to controller_{X} 102. In many typical systems, the amount of the input or output signal tapped to feed the controller is very small, usually on the order of 5% of an input signal and 1% of the output signal. If the output signal is not sufficiently close to the desired result, controller_{X} 102 can vary the power supplied to OC_{X} 100 to effect a greater gain. Controller_{X} 102 can additionally manipulate other variables affecting the performance of OC_{X} 100 to control its performance. In this illustrated embodiment, controller_{X} 102 receives, as input, a portion of the input signal 104. This allows controller_{X} 102 to identify and vary the operational parameters of OC_{X} 100 to provide the desired output as signal 106. Controller_{X} 102 preferably implements both feedforward and feedback control as will be well understood by those skilled in the art. Some systems presently employed in optical networks utilise only one of either feedforward or feedback control.

Signal 106 is provided to OC_{Y} 108 as input. OC_{Y} 108 is controlled by controller_{Y} 110, which can utilise a combination of feedforward and feedback. By receiving a portion of both the input 106 and the output 112 of OC_{Y} 108, controller_{Y} 110 is able to determine the transfer function of OC_{Y} 108 and effect changes to the operational parameters of the optical component to ensure that the desired transfer function is met.

More advanced optical control systems rely upon a detailed calibration of the optical component over several parameter ranges to allow the controller to jump to a near optimal value in a short amount of time, instead of following a critically damped oscillating path that is a characteristic of many conventional control systems.

FIG. 2 illustrates a typical segment of an optical network. The system illustrated in FIG. 1 is encapsulated in Site_{XY} 114. Site_{XY} 114 provides, as its output, signal 112, which is transmitted to Site_{VWZ} 134 over a long haul fiber cable. As is common in most optical networks, Site_{VWZ} 134 receives signal 112′ which is derived from signal 112, but has been subjected to degradation in transmission. Site_{VWZ} 134 receives signal 112′ which is provided to OC_{V} 116 and its controller_{V} 118. OC_{V} 116 provides its output 120 to OC_{W} 122 and its controller_{W} 124. OC_{W} 122 provides its output 126 to OC_{Z} 128 and its controller_{Z} 130. OC_{Z}'s controlled output 132 is the final output of site_{VWZ} 134. Each optical controller controls its associated optical function using known control techniques, including feedforward and feedback control loops as described in relation to the pairing of OC_{X} 100 and controller_{X} 102 in FIG. 1. Standard optical component controllers such as OC_{X} 100 are usually standalone controllers that are connected to their optical component, and may additionally be provided with a means to connect to a network management system to provide status information to the network management system.

Each of the optical components in the network segment illustrated in FIG. 2 can perform different optical functions, or can perform similar functions to form, for example, a multistage amplifier. Each optical component may be able to perform above its specified requirements, either due to the fact that a more robust component was purchased, or due to manufacturing over-design as described above.

Each component is also subject to deterioration in its performance due to aging, stress, or suboptimal operating conditions. In the presently illustrated embodiment, each component is controlled using a combination of feedback and feedforward control. As a result, each controlled component is capable of maintaining its desired output as operational conditions vary. However, if site_{XY} 114, site_{VWZ} 134 or the fiber connecting the two sites is subjected to unexpected conditions it is conceivable that the components of the affected site will not be able to perform to their specifications. As a result, the overall network will suffer from reduced signal integrity or in extreme cases, experience a segment failure. Alternatively, one of the components in a network segment may fail, causing the site as a whole to fail to perform according to its specifications. When a component fails, or a site is exposed to unexpected operating conditions, the signal-to-noise ratio of the network segment decreases. This decrease in the signal to noise ratio results in a diminished channel capacity, as dictated by Shannon's channel capacity theorem. It is conceivable that the components that are unaffected by the failure may have enough excess capabilities to make up for a large portion of the lost capacity due to the failure of a single component. However, there is at present no method or system that will control the components to compensate, as a result, the segment will perform below specifications.

Presently, system level integrators of communications technology do not develop system level controllers for networks through which the data travels. System level control is onerous, as the network is typically comprised of a plurality of components from a plurality of vendors, each utilising a different interface for controlling the optical components. On the other hand, optical component developers form a broad industry of competing suppliers. These suppliers do not typically have the knowledge of the complete environment in which a component will be deployed, thus they do not attempt to provide integrated control of their components according to various network protocols involved in the management of network segments. In many cases the optical components are manually controlled at the local level or even preset for life, at the expense of flexibility and performance margin.

It is, therefore, desirable to provide a system for controlling optical components to provide greater flexibility. In particular, it is desirable to provide a control method and system that can adapt more readily for changes in component level and system level operating conditions.

### SUMMARY OF THE INVENTION

It is an object of the present invention to obviate or mitigate at least one disadvantage of previous optical control systems. In particular it is an object of the present invention to provide improved interaction between controllers through the use of a messaging interface. Another object of the present invention is to provide a messaging oriented method of controlling optical functions.

In a first aspect, the present invention provides a controller for controlling an optical function. The controller includes a messaging interface for communicating with a further controller to establish a control loop governing a behaviour of the optical function in accordance with information received from the further controller.

In an embodiment of the present invention the messaging interface communicates with a plurality of further controllers, and the optical function is determined by the operational parameters of a controlled optical device. In another embodiment of the first aspect of the present invention, the controller controls either a compound optical function or a component optical function. In a further embodiment of the first aspect of the present invention the further controller controls an optical function. In an alternate embodiment of the first aspect of the present invention the messaging interface includes a network management interface for communicating with a network management system, and the further controller is connected to a network management system. In further embodiments of the present invention the information received from the further controller includes information concerning further optical functions, the control loop governs a plurality of sub-control loops and the control loop is based on a model of the behaviour of the optical function.

In a second aspect of the present invention there is provided a method of controlling an optical device. The optical device has both an input and an output and is controlled by an optical controller which stores a model of the optical device. The method comprises the steps of establishing a communications link to a further controller via a messaging interface, receiving from the further controller control information and controlling the optical device based on the received control information and the model.

In an embodiment of the present invention, the step of establishing a communications link includes the step of transmitting a message to the further controller using one of Simple Network Management Protocol (SNMP), Transaction Language 1 (TL1), Command Line Interface (CLI) and an extensible Markup Language (XML) based message, and the step of receiving includes parsing one of an SNMP message, a TL1 message, a CLI message, and an XML based message, or another suitable protocol (proprietary or public) already available or to be developed. In another embodiment of the present invention the step of controlling includes determining control parameters for the optical device based on the received control information and the predetermined model. In further embodiments, the received control information includes a new transfer function relating the output of the optical device to the input of the optical device and the step of controlling includes adjusting the performance of the optical device to meet constraints.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an illustration of a prior art control system for optical components;

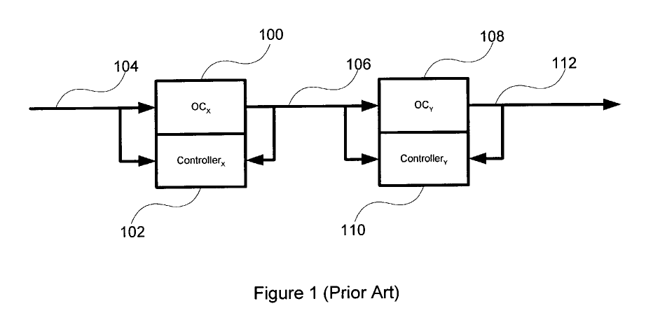

FIG. 2 is an illustration of a prior art network segment;

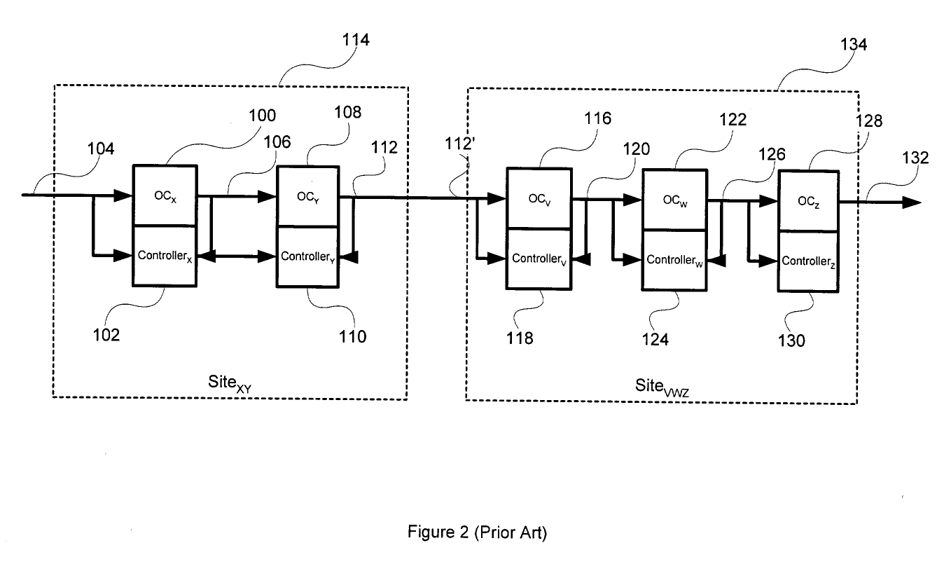

FIG. 3 is an illustration of a system of the present invention; and

FIG. 4 is an illustration of multi-order control loops according to the present invention.

### DETAILED DESCRIPTION

Generally, the present invention provides a method and system for controlling optical functions, and in particular a method and system for controlling optical functions based on communications between controllers. The present invention also permits system level and network level management, control and optimisation.

Optical networks components are typically capable of performing above their rated specifications, or of having the operational parameters varied to modify performance. Modifying the performance of single components is well known. The present invention permits controllers to communicate with each other and can also enable a higher control level to control the single component controllers, to permit them to interact with each other. The control system of the present invention allows each optical function to be controlled based upon the behaviour of surrounding optical functions and overall network performance. Thus, each optical component can still be controlled to meet a desired output, but the output for each component is not statically defined. This allows the overall system to be controlled to compensate for the loss, or degradation, of a number of components or to otherwise control network or site performance.

This multi-level control system is provided by the present invention through the implementation of a messaging interface that allows a variety of controllers to interact with each other. In addition to allowing a control system to alter the output of a number of component optical functions to compensate for a component that is damaged or otherwise not able to function according to specification, the higher level control allows the creation of a compound optical function which includes compensating factors for loss in the communications channels. Thus, in a distributed amplifier or other such system, the present invention allows a controller to monitor the input to the compound optical function, and the output of the overall optical function, and then make corresponding changes to the various internal optical functions to compensate for loss or other impairment of the desired function between the stages in the system. This can be done automatically, and does not require a network planner to monitor the loss between stages and individually tweak each optical function. The automation provided reduces the time required to step up and optimise an optical network segment. Additionally, the interconnected controllers can be connected to a network management system, and can serve as access points for adaptive control or other such optimizing techniques. Furthermore, the interconnection of controllers for optical functions in either a hierarchical or peer-to-peer topology allows for a connection to a network management system. Whereas conventional optical networks can typically remotely monitor the performance of an optical function, the interconnected controllers of the present invention can be provided with new operational parameters, preferably through a messaging interface. This allows a network management system to remotely provision bandwidth on network segments. Thus the controllers of the present invention can be used for both reactionary measures, to compensate for component degradation and failure, and for proactive measures such as reprovisioning of bandwidth. The reprovisioning of bandwidth allows a network management system to proactively shift bandwidth. Additionally, the controllers of the present invention can serve as control access nodes for the network management system to allow optical routers to be controlled to divert traffic from particular network segments for a variety of reasons, including planned network outages for repair. In conjunction with the ability to reprovision network resources such as bandwidth, the ability to dynamically control routing provides the ability to temporarily increase the bandwidth on select network segments to compensate for a planned network outage on another network segment. When the temporary bandwidth increases have taken effect the network can route traffic around the segment for which an outage has been planned, to allow for either repairs or upgrades.

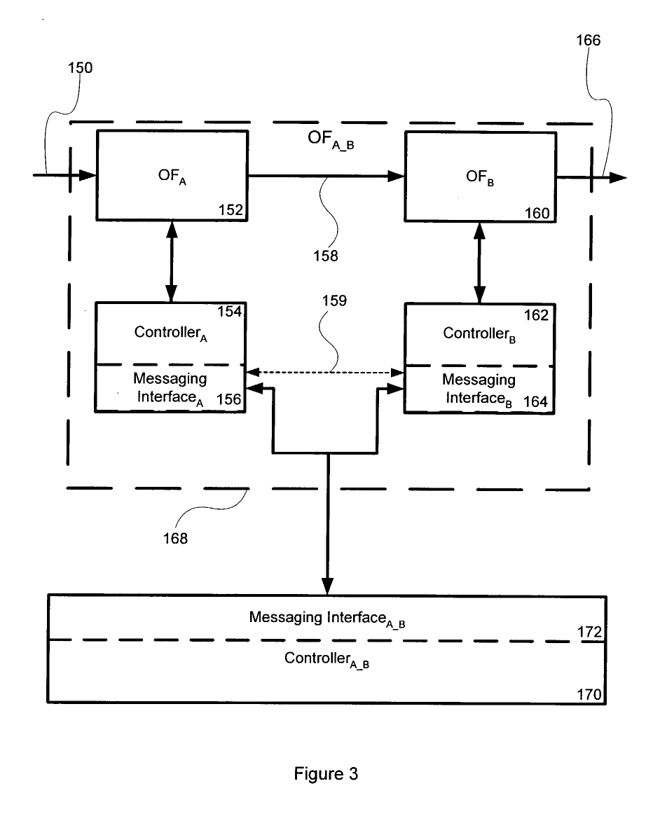

FIG. 3 illustrates a system of the present invention where optical components, modelled as optical functions, are controlled in conjunction with each other. Input signal 150 is provided to Optical Function OF_{A} 152 which is controlled by Controller_{A} 154. Controller_{A} 154 interfaces with OF_{A} 152 either through Messaging Interface_{A} 156 or through an analog connection. Many optical networks presently have a number of legacy optical functions that a controller of the present invention would interface with via a set of analog electrical signals. It is also envisioned that optical functions can be controlled through a standardised messaging interface that allows controller_{A} 154 to use messaging interface_{A} 156 to handle the communications. For the purposes of the following discussion optical functions will be described as being controlled through a messaging interface, though one skilled in the art will readily appreciate that this is not intended to be limiting, and is merely exemplary. OF_{A} 152 is controlled to ensure that its output signal 158 matches desired characteristics. Controller_{A} 154 can implement feedback and feedforward control, either alone or in combination, and a variety of control laws, including Proportional-Integral-Derivative (PID) control, linear quadratic regulator control, sliding mode control, fuzzy logic control, and other control methods known to those skilled in the art. Messaging interface_{A} 156 is used in a presently preferred embodiment to communicate with components in the optical network segment using a standard optical control interface. However, it is contemplated that controller_{A} can be designed, using techniques known to those skilled in the art, to communicate with components in the optical network segment using a combination of direct interfaces, specially designed language interfaces, and the messaging interface_{A} 156. This allows controller_{A} 154 to be used in legacy systems that do not conform to any particular optical control interface. OF_{A} 152 has as its output signal 158, which is received by OF_{B} 160. OF_{B} 160 is controlled by controller_{B} 162 through messaging interface_{B} 164 to provide output signal 166.

A series of component optical functions can be combined and modelled as a single compound optical function. Each of the component optical functions has its own input and output, the output of one optical function being the input for the next, but the compound optical function can be considered to act on the first input, and provide the final output. In the presently preferred embodiment, each of the component optical functions is controlled by its own controller. One skilled in the art will readily appreciate that this does not require that each component is controlled by a separate control circuit, but instead that each component optical function is preferably controlled by a unique control loop, where several control loops can be managed through a single controller chip. Each of the control loops is preferably established as a multiple input control system. The multiple inputs allow each control loop to ensure that each component optical function is controlled to provide an output signal that is closest to a desired output. The desired output, unlike that in the prior art, is changeable through the interaction of the controllers. Thus, a second level controller, in communication with a series of controllers that are interfacing with discrete components, is used to control the compound optical function, by instructing each of the first level controllers what the desired output of each optical function should be. This hierarchical structure can also be implemented as a peer-to-peer system, where the communication of a series of peered controllers creates a multiple input, multiple output control system which is co-ordinated to ensure that the output of the final discrete optical function is as close as possible to the desired output of the compound optical function.

OF_{A} 152 and OF_{B} 160 can be modelled as a single optical function OF_{A}_{_{—}}_{B} 168 acting on input signal 150 to provide output signal 166. OF_{A}_{_{—}}_{B} is controlled by controller_{A}_{_{—}}_{B} 170 through messaging interface_{A}_{_{—}}_{B} 172. Messaging interface_{A}_{_{—}}_{B} 172 allows controller_{A}_{_{—}}_{B} 170 to interact with controller_{A} 154 and controller_{B} 162 through messaging interface_{A} 156 and messaging interface_{B} 164 respectively. This establishment of a higher control level, could alternatively be achieved through the creation of a direct controller link between messaging interface_{A} 156 and messaging interface_{B} 164 to allow controller_{A} 154 and controller_{B} 162 to interact.

Controller_{A}_{_{—}}_{B} 170 is designed to receive information from each of controller_{A} 154 and controller_{B} 162 to determine if either of OF_{A} 152 or OF_{B} 160 is unable to perform according to the specifications. If, for example, OF_{B} is an optical amplifier and is unable to provide its required gain, controller_{A}_{_{—}}_{B} 170 can direct controller_{A} 154 to increase the gain of OF_{A} 152, so that OF_{A}_{_{—}}_{B} 168 is able to provide gain as close to the desired output as possible. Additionally the messaging functionality can be utilised to allow the operational parameters of a network, or a network segment, to be changed to achieve a number of goals. If a particular set of amplifiers is known to generate too much noise above a certain gain level, they can be restricted to a lower gain level, and other amplifiers in the segment can be used to compensate for the lost amplification. Alternatively, a network segment may receive a signal at a certain power level, and be expected to provide the signal at its output at another power level, and the individual components can be controlled to average out power consumption, maximise component life, or any of a number of other desired optimizations. Network level control provides the ability to specify desired optimizations, such as those described above, that cannot be easily satisfied in a system with only component level control.

As noted above, controller_{A}_{_{—}}_{B} 170 is able to monitor the input signal 150 and output signal 166 to determine if OF_{A}_{_{—}}_{B} is meeting the desired transfer function. If the desired output is not being obtained, due to loss or other such factors, the individual transfer functions of OF_{A} 152 or OF_{B} 160 can be adjusted to compensate for the unmodelled loss. Thus the transfer function of compound optical function OF_{A}_{_{—}}_{B} 168 can be maintained despite either unmodelled losses, or degraded performance of either of the component optical functions. Additionally illustrated in relation to controller_{A} 154 and controller_{B} 162 is an optional connection 159 between the two controllers. A peer-to-peer connection between messaging interface_{A} 156 and messaging interfaces 164 allows controller_{A} 154 and controller_{B} 162 to interact with each other without requiring intervention of controller_{A}_{_{—}}_{B} 170. This peer-to-peer relationship can be used to correct minor deficiencies without the delay of interfacing with a higher control level. Controller_{A}_{_{—}}_{B} 170 is still used in this illustrated embodiment to serve as a single interface with a higher level of control, such as a network management system, so that from a remote location, OF_{A} 152 and OF_{B} 160 can still be treated as a single optical function, OF_{A}_{_{—}}_{B} 168. In some embodiments of the present invention, Controller_{A}_{_{—}}_{B} 170 may be omitted, and replaced with additional logic within controller_{A} 154 and controller_{B} 162. Coordination between controller_{A} 154 and controller_{B} 162 is then achieved by communication of the controllers through either common messaging interface_{A}_{_{—}}_{B} 172 or through a peer-to-peer connection between messaging interface_{A} 156 and messaging interface_{B} 164.

The controller of each component optical function is preferably provided with a detailed calibration of the component, so that it is capable of quickly varying the controlled inputs to move the transfer function of a component optical function to the desired level. Typically, when provided with a detailed calibration of the component optical function, the control of an optical function can be provided through changing an input to a level determined by examining a stored virtual equivalent of a look-up table, or an equivalent thereof. As components age, their performance characteristics are known to drift from the initial calibration. To compensate for this, in a presently preferred embodiment of the invention, the component optical function controller is able to perform an in situ calibration of the controlled component optical function. The in situ calibration is used, in a presently preferred embodiment, to determine a new look up table for the controller to use. In a presently preferred embodiment, the newly determined characteristics of the component optical function are provided to the compound optical function controller so that the compound optical function controller can determine how much excess capacity is available. This information can then be used to determine how much each component optical function can be modified to provide the desired transfer function for that compound optical function.

In an example of the present invention, controller_{A} 154 and controller_{B} 162 can be provided by different manufacturers, and cannot directly communicate with each other. In this embodiment, the communication between controller_{A} 154 and controller_{B} 162 is performed through compound optical function controller_{A}_{_{—}}_{B} 170. Messaging interface_{A}_{_{—}}_{B} 172 of controller_{A}_{_{—}}_{B} 170 can communicate with each component controller using a different instruction set, so that the required information can be passed between them. This provides a turnkey solution to network planners who already have established networks whose components are locally controlled, but unable to be globally controlled due to the difference in the interface requirements.

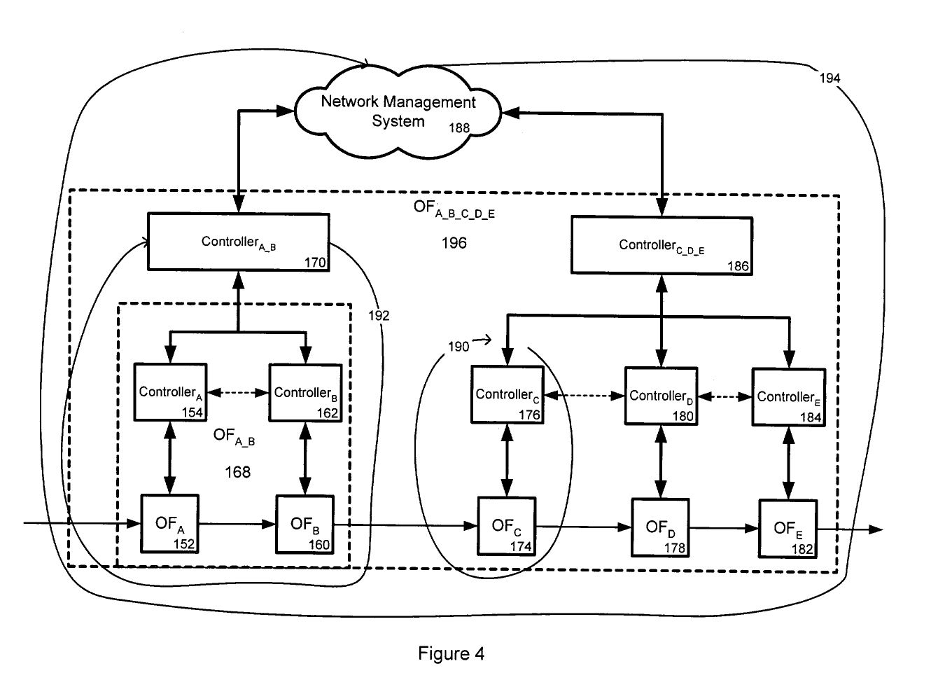

FIG. 4 illustrates a network segment controlled according to an embodiment of the present invention. As described above, controller_{A}_{_{—}}_{B} 170 controls the interaction of OF_{A} 152 and OF_{B} 160 through their respective controllers, controller_{A} 154 and controller_{B} 162. Not illustrated in FIG. 4 is the messaging interface, which has been omitted for the sake of clarity in the following discussion. However, each controller includes a messaging interface, as described above, to permit the intercommunication between controllers. A compound optical function controller, controller_{C}_{_{—}}_{D}_{_{—}}_{E} 186, is used to control OF_{C} 174, OF_{D} 178 and OF_{E} 182 through their respective component optical function controllers, controller_{C} 176 controller_{D} 180 and controller_{E} 184. As illustrated, controller_{A}_{_{—}}_{B} 170 is connected to controller_{C}_{_{—}}_{D}_{_{—}}_{E} 186 through a network management system 188. Network management system 188 is employed to manage the overall network segment, and may operate through the use of a command line interface (CLI), the Simple Network Management Protocol (SNMP), Transaction Language 1 (TL1), extensible Markup Language (XML), among other formats. Network management system 188 preferably includes a compliant messaging interface, or is capable of interpreting messages from the compound function controller messaging interfaces. Network management system 188 may provide a simple peer-to-peer link between controller_{A}_{_{—}}_{B} and controller_{C}_{_{—}}_{D}_{_{—}}_{E}, using their respective messaging interfaces, or may provide a third hierarchical level of control. Those skilled in the art will readily appreciate the implementation of either method of communication.

Each component optical function controller interacts with its component optical function to provide a first order control loop. One such first order control loop is illustrated as control loop_{C} 190. Control loop_{C} 190 governs the behaviour of OF_{C} 174. First order control loop_{C} 190 is created by controller_{C} 176 which varies the operational parameters of OF_{C} 174 to provide the desired transfer function. One skilled in the art will readily appreciate that such first order control loops are known in the art. The messaging interfaces of the controllers of the present invention allow a hierarchical control structure to be developed, so that higher order control loops can be created. A second order control loop is illustrated as control loop_{A}_{_{—}}_{B} 192. Control loop_{A}_{_{—}}_{B} 192 governs the behaviour of OF_{A}_{_{—}}_{B} 168. Control loop_{A}_{_{—}}_{B} 192 is created by controller_{A}_{_{—}}_{B} 170. Controller_{A}_{_{—}}_{B} 170 varies the operational parameters of OF_{A}_{_{—}}_{B} 168 to provide control of the transfer function between the input of OF_{A} 152 and the output of OF_{B} 160. Control of the component optical functions is achieved through the use of the messaging interface of controller_{A}_{_{—}}_{B} 170 to communicate to the messaging interfaces of controller_{A} 154 and controller_{B} 162. Alternatively, a direct peer-to-peer connection between controller_{A} 154 and controller_{B} 162 can be provided as illustrated by the dashed line 159 between them. This optional peer-to-peer connection can be used to govern control loop_{A}_{_{—}}_{B} 192 in place of controller_{A}_{_{—}}_{B} 170, or it can be used to supplement controller_{A}_{_{—}}_{B} 170 as described above.

Compound optical functions, such as OF_{A}_{_{—}}_{B} 168, can be combined into higher order compound functions such as OF_{A}_{_{—}}_{B}_{_{—}}_{C}_{_{—}}_{D}_{_{—}}_{E} 196. OF_{A}_{_{—}}_{B}_{_{—}}_{C}_{_{—}}_{D}_{_{—}}_{E} 196 is governed by a third order control loop_{A}_{_{—}}_{B}_{_{—}}_{C}_{_{—}}_{d} _{_{—}}_{E} 194. Control loop_{A}_{_{—}}_{B}_{_{—}}_{C}_{_{—}}_{D}_{_{—}}_{E} 194 is governed by either a controller in network management system 188, or through the peer-to-peer interaction of controller_{A}_{_{—}}_{B} 170 and controller_{C}_{_{—}}_{D}_{_{—}}_{E} 186. A direct connection between controller_{A}_{_{—}}_{B} 170 and controller_{C}_{_{—}}_{D}_{_{—}}_{E} 186 has not been illustrated, as the peer-to-peer connection is typically supported over the network management system 188, though it is envisioned that a direct connection can be provided similar to that between the first level optical controllers in a given site. Control loop_{A}_{_{—}}_{B}_{_{—}}_{C}_{_{—}}_{D}_{_{—}}_{E} 194 is governed to ensure that the transfer function relating the input to OF_{A} 152 and the output of OF_{E} 182 is maintained.

In operation, the third order control loop_{A}_{_{—}}_{B}_{_{—}}_{C}_{_{—}}_{D}_{_{—}}_{E} allows dynamic recovery for a complete or partial failure of a component optical function. For example, if a component optical function is damaged, its component optical function controller relays the new component parameters, reflecting the decreased capabilities of the component optical function to the second order controller. Alternatively, the component optical function controller can be designed to recalibrate the optical function at fixed intervals to provide an up-to-date listing of the characteristics of the optical function. One skilled in the art will appreciate that the data obtained in such periodic recalibrations can be used to track the aging of optical functions for preventative maintenance in the system. The first order, or component level, controller can gather these characteristics through the use of a number of techniques known to those skilled in the art, including an in situ calibration of the component to determine its operational parameters. The second order controller then communicates the updated optical component parameters to the third order control loop 194. With the new parameters for one of the component optical functions, the third order control loop 194 directs its component optical functions, which in this example are compound optical function OF_{A}_{_{—}}_{B} 176 and OF_{C} _{_{—}}_{D}_{_{—}}_{E}, to compensate for the diminished capacity. In a specific example, OF_{D} 178 is an optical amplifier in a multistage amplified segment. In the network segment specifications, OF_{D} 178 is required to provide 6 dB of gain. As a result of stress induced damage or degradation, OF_{D} 178 is only able to provide 4.5 dB of gain. In response to being unable to achieve a desired transfer function controller_{D} 180 performs an in situ calibration of OF_{D} 178. The calibration results in new operating parameters that indicate that OF_{D} 178 can only provide 4.5 dB of gain. Controller_{D} 180 then relays this updated calibration information to controller _{D}_{_{—}}_{E}_{_{—}}_{F} 186. Controller_{D}_{_{—}}_{E}_{_{—}}_{F} 186 instructs controller_{C} 176 and controller_{E} 184 to adjust their transfer functions to increase the gain that OF_{C} 174 and OF_{E} 182 provide. If controller_{C} 176 and controller_{E} 184 can adjust their transfer functions to provide the full 1.5 dB lost the network segment is repaired. In a presently preferred embodiment, controller_{D}_{_{—}}_{E}_{_{—}}_{F} 186 transmits a message into network management system 188 so that network administrators are notified of the damaged component.

However, if controller_{C} 176 and controller_{E} 184 cannot adjust their transfer functions to provide all of the additional 1.5 dB gain, controller_{A}_{_{—}}_{B} 170 is requested to increase its gain, so that the transfer function of control loop_{A}_{_{—}}_{B}_{_{—}}_{C}_{_{—}}_{D}_{_{—}}_{E} 194 is maintained. In response to this request, controller_{A}_{_{—}}_{B} 170 will change the transfer functions of controller_{A} 154 and controller_{B} 162 so that they make up the balance of the missing 1.5 dB. This allows the network segment to be fully repaired. Once again, controller_{D}_{_{—}}_{E}_{_{—}}_{F} 186 preferably transmits a message into network management system 188 so that network administrators are notified of the damaged or degraded component.

Though as described above, controller_{C}_{_{—}}_{D}_{_{—}}_{E} 186 preferably attempts to modify the transfer functions of its component optical functions, it is contemplated that in other embodiments of the present invention controller_{C}_{_{—}}_{D}_{_{—}}_{E} 186 and controller_{A}_{_{—}}_{B} 170 would share the extra 1.5 dB gain using a number of different division methods. Such methods may be used to divide the extra load among the components to ensure that they are not subjected to extended periods of time in which they must operate outside of their specified operational ranges, or to satisfy other constraints placed upon the system. Such constraints may include increasing the amplification at one site over another so that the cost of consumed power is decreased, or so that amplifiers known to introduce less noise into the system are used to make up the difference wherever possible. In an alternate embodiment of the present invention, the messaging controllers can be used to control a series of pumps in a distributed Raman amplifier. If one of the pumps fails, or is severely impaired in its ability to provide the required output, the communication between the controllers will allow the other pumps to provide additional power until the damaged pump is either repaired or replaced. One skilled in the art will readily appreciate that the control of a pump laser can be used to feed back a calculated gain shape so as to shift the frequency of a tuneable laser to shift to a new frequency so as to allow a Raman amplifier to optimise the gain shape of other devices in a network segment of span. This allows for the opimising of the gain shape of other devices to compensate for the shifted wavelength, Thus, the controller of the present invention provides the ability to self heal a pump laser, and have the rest of the components in the network segment adjust for the new pump parameters.

The communication between component optical function controllers, either directly with each other, in a peer-to-peer relationship, or indirectly, through a master-to-slave relationship allows a network integrator to exert remote control over key parameters determining the performance of the system, as well as to monitor and correct for factors (aging related drift, unmodelled losses, noise, etc.) that can seriously affect the Quality of Service (QoS) delivered by a network segment. In addition, by using electronic controls to manipulate the management and handling of the optical signals, it is possible to maintain the signals in the optical domain as far as possible. Those skilled in the art will readily appreciate that allowing signals to remain in the optical domain is generally advantageous for the overall system operation.

In one embodiment of the present invention, the messaging structure of the inter-controller communication is based on the various optical and photonic devices being modelled as ‘objects’ in the software sense of the term, such that a highly efficient and compact operating system can be used to rapidly connect to and modify the settings of the various devices. This capability offers addressed messaging to and from the optical component controllers, through their messaging interfaces. This enables optimization between neighbouring optical functions. Additionally, it provides optimization in the context of the higher level system management needs.

From the view of a network planner, the combination of the component optical function controllers and the compound optical function controllers provides for a range of different interface protocols that can be controlled by a single network control panel, including: CLI, SNMP, TL1, XML, and other formats that may be user-defined or specified.

In a presently preferred embodiment, the controller also offers a necessary range of interface formats for linking adjacent optical functions so that the compound optical function can be optimized for maximum power and noise efficiency as well as providing paths for coordinated setup of device sets to adapt to initial or changing operating contexts. The flexibility to adapt to these different interface requirements is preferably facilitated by configurable software running on an optimized hardware platform. One capability that this presently preferred embodiment enables is a translation functionality to support multiple standard protocols at the network management level, and proprietary protocols, such as command line interfaces, at both the network and device levels.

One skilled in the art will readily appreciate that though a number of examples using amplifiers have been described, other optical components such as dynamic gain equalisers can be controlled in series with other components to ensure that gain is equalised, and that phase distortions are not introduced. Other such optical components including pumps, multiplexers, such as wavelength division multiplexers, polarizing filters and wavelength filters can also be controlled to create a dynamically varying optical network that is fully controllable from a centralised access point. As described above, the controllers of the present invention can be used to adjust components for the new parameters of self-healing pumps, and allow for reprovisioning of network resources, such as bandwidth, to allow for a variety of network management services.

One skilled in the art will appreciate that the method of network segment control described with relation to one embodiment of the present invention can be represented as control of a plurality of optical functions, by altering the transfer function relating to each optical function, to compensate for changing conditions relating to other optical functions in the network segment. Furthermore, the present invention can be described as network management instead of a control of network elements. The network management of the present invention is provided through the use of messaging architecture of the messaging interface in both the component optical function controller and the compound optical function controller. The messaging architecture allows the control of the devices based on knowledge of the components in the system. The messaging interface aspect of the present invention also enables methods of in situ calibration of network performance and in situ optical device calibration as described above. The control of compound optical functions as described above provides a network planner with the ability to design a network that can compensate for degradation or failure of an optical function by changing the transfer function of other optical functions in a higher level compound optical function. This also provides a network that is capable of automated optimization through the use of multi-objective optimization techniques that will be understood by those skilled in the art.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A controller for controlling an optical function comprising:
a messaging interface for communicating with a further controller to establish a control loop governing a behaviour of the optical function in accordance with information received from the further controller.

2. The controller of claim 1, wherein the messaging interface communicates with a plurality of further controllers.

3. The controller of claim 1, wherein the optical function is determined by the operational parameters of a controlled optical device.

4. The controller of claim 1, wherein the controller controls a compound optical function.

5. The controller of claim 1, wherein the controller controls a component optical function.

6. The controller of claim 1, wherein the further controller controls an optical function.

7. The controller of claim 1, wherein the messaging interface includes a network management interface for communicating with a network management system.

8. The controller of claim 1, wherein the further controller is connected to a network management system.

9. The controller of claim 1, wherein the information received from the further controller includes information concerning further optical functions.

10. The controller of claim 1, wherein the control loop governs a plurality of sub-control loops.

11. The controller of claim 1, wherein the control loop is based on a model of the behaviour of the optical function.

12. A method of controlling an optical device having both an input and an output, the optical device controlled by an optical controller, the controller storing a model of the optical device, the method comprising:
establishing a communications link to a further controller via a messaging interface;
receiving from the further controller control information;
controlling the optical device based on the received control information and the model.

13. The method of claim 12, wherein the step of establishing a communications link includes the step of transmitting a message to the further controller using one of Simple Network Management Protocol (SNMP), Transaction Language 1 (TL1), Command Line Interface (CLI) and an extensible Markup Language (XML) based message.

14. The method of claim 12, wherein the step of receiving includes parsing one of an SNMP message, a TL1 message, a CLI message, and an XML based message.

15. The method of claim 12, wherein the step of controlling includes determining control parameters for the optical device based on the received control information and the predetermined model.

16. The method of claim 15, wherein the received control information includes a new transfer function relating the output of the optical device to the input of the optical device.

17. The method of claim 12, wherein the step of controlling includes adjusting the performance of the optical device to meet constraints.
